(19) United States
(12) Patent Application Publication
(10) Pub. No.: US 2018/0119678 A1
(43) Pub. Date: May 3, 2018

(54) MEASURING ASSEMBLY ON A WIND TURBINE

(71) Applicant: WOBBEN PROPERTIES GMBH, Aurich (DE)

(72) Inventor: Rodolphe LEBOSQ, Eversmeer (DE)

(21) Appl. No.: 15/814,283

(22) Filed: Nov. 15, 2017

Related U.S. Application Data
(63) Continuation-in-part of application No. PCT/EP2016/059682, filed on Apr. 29, 2016.

(30) Foreign Application Priority Data
May 19, 2015 (DE) 102015209109.0

(51) Int. Cl. F03D 17/00; F03D 7/02; G01P 5/02; G01P 13/02

(52) U.S. Cl. CPC F03D 17/00; F03D 7/0224; F03D 1/0666; G01P 13/025; G01P 5/02

(57) ABSTRACT

The disclosure relates to a measuring arrangement of a wind power plant having a tower and an aerodynamic rotor with at least one rotor blade, for sensing wind conditions, comprising at least a first and a second measuring device for arrangement at different heights on the tower, and wherein each measuring device is prepared so as to sense, at the respective height at which it is to be arranged, wind values for different horizontal directions, said values being representative of a wind pressure from the respective direction.

### BACKGROUND

### Technical Field

The present arrangement relates to a measuring arrangement of a wind turbine for sensing wind conditions, to a method for sensing wind conditions and to a method for operating a wind turbine. In addition, the present invention relates to a wind turbine.

### Description of the Related Art

Wind turbines which generate electrical energy from the kinetic energy of the wind and feed it into an electrical power supply grid are generally known.

For the control of such wind turbines it is helpful if the wind conditions which are present at the wind turbine, for example the wind speed and/or the wind direction, are known.

More accurate determination of the wind conditions permits better operation of such a wind turbine, particularly permits it to be operated more economically and/or in a way which provides more support to the power grid.

In particular, the volume flow of the wind, which can also be referred to as wind volume flow, which flows through the swept rotor area of a wind turbine, is decisive for the output of a wind turbine. The swept rotor area, which is also referred to as the rotor area, is understood to be the circular area through which the rotor blades of a wind turbine pass during operation. In order to utilize the wind as well as possible, the wind turbine is made to track the wind in its azimuth position. This is done by means of what is referred to as azimuth control, which for the purpose of control usually senses a wind direction on the nacelle of the wind turbine. In this context, the wind conditions have mostly been sensed earlier by means of mechanical anemometers and/or anemoscopes.

It is known that the wind conditions which are present at a wind turbine can exhibit what are referred to as wind veer effects and wind shear effects which can have a very large influence on the operation of the wind turbine.

Such variants in the wind cannot be sensed by means of an anemometer and/or an anemoscope on the nacelle. This can result in a situation in which a wind turbine which is operated in this way is not operated to an optimum degree, particularly with an excessively low coefficient of power or efficiency level.

DE 10 2012 210 150 A1 discloses, for example, the use of microwave technology and radarwave technology for sensing wind conditions. In addition, the person skilled in the art is also familiar with the use of LIDAR and SODAR methods, that is to say laser-assisted or acoustic long-distance measuring methods for sensing wind conditions.

A disadvantage of the use of such long-distance measuring methods in the field of wind turbines is, in particular, the high level of technical expenditure and the associated costs. Owing to the high costs, for example over 100 000 euros for a ground-based LIDAR device, LIDAR devices are usually used only once, as mobile devices for location certification. Accordingly, the wind shear and the wind veer for the respective location are defined only once in a rigid way and an operating characteristic curve is designed for the respective location on the basis of this rigid definition.

The German Patent and Trademark Office has also examined the following prior art: US 2013/0272877 A1 and WO 02/079645 A1 in the matter of the priority filing for the present application.

### BRIEF SUMMARY

Provided is an arrangement and method which permits the wind shear and wind veer to be measured and/or taken into account as well as possible, and therefore a method which is suitable, in particular, for economical use in the field of wind turbines. The present method should as far as possible be able to sense the wind shear effects and wind veer effects without having to measure the location in advance, under certain circumstances as a function of the time of day. A measuring arrangement of a wind turbine having a tower and an aerodynamic rotor with at least one rotor blade, for sensing wind conditions is therefore proposed, wherein the measuring arrangement has at least a first and a second measuring device for arrangement at different heights on the tower, and each measuring device is prepared so as to sense, at the respective height at which it is arranged, wind values for different horizontal directions, said values being representative of a wind pressure from the respective direction. This is to be understood in particular as meaning a value which brings about at the measuring device a pressure or a pressure profile which can be assumed to be generated by the wind. In the simplest case, a pressure measurement is carried out.

The measuring arrangement for sensing wind conditions accordingly comprises at least two measuring devices, wherein each measuring device has at least one measuring pickup for generating at least one measurement signal. A measuring arrangement therefore generates at least two parallel measurement signals which are essentially synchronous, wherein the at least two measurement signals are representative of the wind pressure. They can, for example, indicate the wind pressure directly or be a proportional signal, to name just two examples.

In order to generate measurement signals in a way which is representative of a wind pressure, it is proposed, for example, in one embodiment, that the measuring device is designed to sense wind conditions as a pressure sensor and has one, several or many pressure sensors or other sensors. It is also possible, for example, to consider nanosensors.

In addition, it is proposed that the measuring devices are embodied in such a way that they can be attached to a tower which can be a mast. They can also, for example, be bonded on and have an adhesive layer for that purpose. However, in this context they also interact in the measuring arrangement. They must at least be coupled in such a way that their measured values are evaluated together.

The arrangement of the measuring devices at different heights on the tower and the acquisition of wind values in the horizontal direction, that is to say in different compass directions, including intermediate directions, prepares the measuring arrangement in such a way that it senses variations in the wind conditions as a function of the height. As a result of the sensing of different wind directions as a function of the height, the variation of the wind direction with the height can therefore be sensed, that is to say at least one wind veer value can be sensed. At least one so-called wind shear value can be sensed by sensing the amplitude of the wind pressure and therefore a wind speed at different heights.

In addition, the measuring devices at each height can have a plurality of measuring pickups. By distributing these measuring pickups, particularly over the circumference of the tower, it is possible to sense well changes in horizontal wind conditions, for example wind directions.

Preferably, the measuring pickups of each measuring device are embodied in such a way that they can completely sense the wind or wind conditions around the tower in a 360° profile of the horizontal direction, that is to say all around the tower, in order then to be able to produce and evaluate a 360° profile.

The at least two wind characteristics or horizontal wind profiles which are generated in this way can be processed by a computational and/or evaluation unit to form a three-dimensional wind map or some other data set which compiles the sensed wind conditions. Such a three-dimensional wind map vectorially maps the wind conditions here in the region of the wind turbine, in particular in the region of the swept rotor area.

It is proposed that the sensed wind conditions or sensed wind data, in particular the abovementioned three-dimensional wind map or the other data set which compiles the sensed wind conditions, be used to control the wind turbine. In particular, such wind data can be evaluated and control values subsequently derived therefrom can be passed on to an azimuth controller and/or pitch controller of the wind turbine.

It is preferably proposed that a third measuring device be arranged on the tower in order to improve the accuracy and/or the depth of the information. In order to improve the sensing accuracy even further, a fourth or even fifth or even further measuring devices are proposed. For turbulent locations or wind turbines with large rotor diameters, three, four, five or more measuring devices and therefore measuring devices at three, four, five or even more different heights are proposed.

At least the first and the second measuring devices are preferably prepared for arrangement around the tower. The first and second measuring devices of the measuring arrangement then enclose the tower essentially horizontally. For this purpose it is possible to provide any measuring device, for example, as a belt which is positioned around the tower at a corresponding height. It is possible, for example, for it to be formed as a belt with a large number of distributed sensors and, in particular, as an adhesive belt bonded once around the tower. However, other means of attachment can also be considered.

Instead of a belt which completely surrounds the tower it is also possible for distributed and separately arranged sensors to form in each case a measuring device at a height. Essentially, the measuring device is to be prepared so as to map the wind conditions around the tower in the horizontal direction over 360° or to record for this purpose the data which can provide such an image. It is also possible to provide a very large number of sensors, for example 100 sensors, to provide an illustrative example, right next to one another, said sensors being arranged in a quasi-continuous fashion with a quasi-continuous local distribution of measured values.

In particular, by means of an annular and/or belt-like structure the measuring devices are prepared so as to sense the wind conditions over 360° in the horizontal direction.

At least the first and second measuring devices are preferably prepared so as to sense as the wind value in each case the wind pressure, that is to say the force of the wind or the wind load acting on the respective surface of the respective measuring pickup. The wind direction and the wind strength or wind speed can be derived therefrom. A measuring device can therefore sense the wind direction and strength of the wind simultaneously.

Each measuring device preferably comprises a pressure sensor film which is prepared to sense a direction-dependent pressure profile.

Such a pressure sensor film can have a large number of sensors, in particular so many that it behaves like a large, locally distributed pressure sensor which can sense location-dependent pressure values. According to one embodiment, it records, quasi-continuously, measured values which are distributed over the horizontal direction.

Pressure sensor films are measuring pickups or measuring sensors which are essentially embodied in a particularly thin way, manufactured as webs and permit particularly easy installation on the tower of a wind turbine by virtue of their properties. It is therefore preferably proposed that the pressure sensor film be attached to the tower by means of simple bonding on. Said pressure sensor film can therefore sense the wind pressure as a function of the direction, in particular continuously or quasi-continuously over 360° in the horizontal direction.

According to a further embodiment, the pressure sensor film is a piezo-electric film or a nanosensor film.

In the case of piezo-electric films, also referred to as piezo-film sensors, an electrical voltage which is proportional to the force is generated by means of pressure. Accordingly, piezo-electric films generate what is referred to as the piezo-electric effect. Nanosensor films in contrast generate a voltage which is representative of the pressure and which is not based on the piezo-electric effect. Both the electrical voltage generated by the nanosensor and that generated by the piezo-film sensor can be pre-processed by means of charge amplifiers and/or diaphragms to form a measured value in a way which is representative of the wind pressure.

When using piezo-electric pressure sensors films it is particularly advantageous that the piezo-electric films are, precisely like the nanosensor films, very robust with respect to environmental influences and can therefore be used at almost all wind turbine locations in the world. In addition, piezo-electric films have, precisely like nanosensor films, a high degree of chemical inertia, which gives rise to low maintenance expenditure.

As one embodiment it is proposed that the first measuring device be arranged at a height on the tower at which the blade tip passes the tower during the rotation of the rotor. It is therefore possible to record wind values for the lower edge of the rotor face.

Firstly, almost the entire lower half of the swept rotor area can be covered in terms of measuring technology, in particular together with a further measuring device directly underneath the nacelle and/or hub of the wind turbine. Areas above the nacelle can be extrapolated.

According to a further embodiment, it is therefore also proposed to arrange the second measuring device above the first measuring device, in particular directly underneath the nacelle of the wind turbine.

The measuring arrangement preferably has a least a third measuring device which, according to regulations, is arranged on the tower at a height between the first and the second measuring device, preferably centrally between them.

As a result, the accuracy of the determination of wind distribution can be particularly improved with the height. By means of interpolation, values can be calculated at heights between the measuring devices.

At least one value of wind shear is preferably determined or calculated over the height on the basis of the values which the measuring arrangement records, which can also synonymously be referred to as the wind shear value and/or at least one value of a change in direction is determined or calculated over the height, which value can also be synonymously referred to as the wind veer value. The two values are preferably determined or calculated and/or in each case a height-dependent function is determined.

Changes to the wind speed with the height, referred to as wind shear, and/or changes to the wind direction with the height, also referred to as wind veer, can therefore be determined in a simple and cost-effective way and used to improve the plant control. The wind speed frequently increases with the height, but it can also in principle be possible for the wind speed to decrease as the height increases. The use of a characteristic variable, that is to say of a wind veer value or of a wind shear value, can already be helpful here. The evaluation can be improved by setting up in each case a function depending on the height. Such a function can be, for example, a 2nd order polynomial function which are parametrized on the basis of in each case three values, specifically one value per measuring device, if three measuring devices are used.

It is preferably proposed to determine a measure of wind turbulence from the values which the measuring arrangement records. In this context, in addition to fluctuations in the wind at a measuring sensor, fluctuations in the wind over the height and/or fluctuations in the wind direction at different heights can be evaluated.

By sensing wind values in different horizontal directions and at different heights it is possible to sense eddying of the atmospheric boundary layer close to the ground, referred to as wind turbulence. In particular, for this purpose a change in the wind speed and the wind direction over the height are determined. In addition, the intensity of the turbulence and/or a gust factor can be determined from the wind values which are sensed by the measuring arrangement in this way.

A method for sensing a wind distribution in the case of a wind turbine having a tower and an aerodynamic rotor with at least one rotor blade is also proposed, wherein wind values are sensed at different heights on the tower and direction-dependent wind values are recorded for different horizontal directions at the different heights. The direction-dependent wind values which are recorded in this way are representative here of a wind pressure from the respective horizontal direction. It is proposed to operate the method in the way which is apparent from the explanations relating to at least one of the embodiments of the measuring arrangement above.

A particular technical advantage of the proposed method is that wind shear values and wind veer values or functions can be recorded without using complicated and expensive special measuring devices. As a result it becomes possible to record such wind condition values on any wind turbine and even implement such an improvement for basically any wind turbine.

A method for operating, in particular for controlling, a wind turbine is also proposed, wherein the wind turbine is operated as a function of a wind distribution which is determined in accordance with at least one embodiment explained above.

The wind values which are sensed, in particular the wind speed and the wind direction and the resulting change in the wind speed over the height and/or the change in the wind direction over the height can be used to control the wind turbine in such a way that the wind turbine is operated in an optimum way by means of the azimuth control and/or pitch control at a desired, in particular stable, working point. For the pitch control it is also possible to control the rotor blades individually, specifically to set their pitch angles in accordance with the position of the respective blade and the sensed, height-dependent wind situation. Circulation-specific values for the pitch angle can preferably be derived or calculated from the wind values which are sensed as a function of the height.

A wind direction is preferably determined at least at the first height and the second height, respectively, and a change of wind direction over the height (wind veer) is determined therefrom qualitatively and/or quantitatively.

According to one embodiment it is proposed to assume, at the respective height of the measuring device, the horizontal direction with the largest wind value as the wind direction at the respective height.

When wind values of horizontal directions are sensed, wherein the wind values are representative of a wind pressure, the largest wind value can be adopted as the wind direction with sufficient accuracy.

The largest wind value or the amplitude of the sensed wind values is understood to mean the global maximum value of the measured values at the respective height, which maximum value is representative of the wind. It is therefore possible, for example, on a measuring device, also for local maximum values to occur as a result of noise, said maximum values occurring as a result of measuring errors and/or signal errors and not being representative of the wind. In order to prevent incorrect values being assumed as the amplitude, it is possible, for example, to use filters or to pre-process the measurement signals in some other way.

In addition, the largest wind value is not limited to an individual measured value but instead the largest value can also be from averaging of all the sensed values at the respective height, for example by means of sliding averages. Even if a local minimum value lies in a narrow range between two maximum values in the wind direction, it is possible to form a single maximum, which indicates the wind direction, by averaging or filtering in some other way.

One refinement provides for a wind speed to be determined at least at the first height and the second height and for wind shear over the height, that is to say at least one wind shear value, to be derived therefrom.

A wind speed at the respective height is preferably derived in each case from the largest wind value at the respective height, that is to say from all the wind values recorded over 360° at the respective height.

The wind values which are sensed at the respective height form a type of wind profile, wherein the wind profile represents the flow of the wind at the respective height on the tower. In addition, the sensed wind values at the respective height have precisely one maximum value and one amplitude which is representative of the wind direction or indicates it.

In each case a corresponding wind speed for the respective height is derived from the amplitudes which is representative of the wind direction or the largest wind values. For this purpose, for example the reference voltage, generated by the wind pressure, of a pressure sensor measurement film is converted into a wind speed by means of a computational and/or evaluation unit.

A wind veer profile or a wind shear profile is preferably calculated from the change of wind direction over the height, that is to say the wind veer and/or the wind shear over the height for a swept rotor area of the wind turbine, in particular by interpolation and/or extrapolation.

By means of at least two changes in the wind direction and/or wind shear values sensed at different heights it is possible to calculate the change in the wind direction and/or wind shear over the height for the swept rotor area through which the wind passes.

For such calculation, the sensed wind values can be extrapolated and/or interpolated, for example over the swept rotor area. This can be done either numerically or else by means of predefined n-th order polynomials.

As the number of values increases, particularly also as the number of measuring devices distributed over the height increases, the extrapolation or interpolation becomes more accurate. The profiles which are created by extrapolation or interpolation can also be referred to as wind veer profiles or wind shear profiles, since they can map the wind veer effect or wind shear effect for the entire swept rotor area of a wind turbine.

At least one azimuth angle and/or one pitch angle of the wind turbine is preferably changed as a function of at least one wind shear value and/or one wind veer value and/or one wind shear profile and/or one wind veer profile.

It is possible to improve the control of the wind turbine by means of the variables or criteria which relate to the wind shear or the change in the wind shear over the height and are derived from the values. For this, for example a wind shear value or wind veer value is compared with a look-up table. For example empirically determined azimuth angles or pitch angles serve as the return values from the look-up table and, after they have been retrieved, they are used as reference variables or manipulated variables. According to another embodiment, the wind shear profiles and/or wind veer profiles which are determined are included as interference variables in the azimuth control and/or pitch control of the wind turbine.

A measuring arrangement according to at least one embodiment described above is preferably used for the proposed methods.

In particular, the use of three measuring devices constitutes a particularly preferred embodiment of the proposed methods, wherein the first measuring device is arranged at the height of the blade tip when the latter passes the tower, that is to say at a 6 o'clock position of the respective rotor blade, the second is arranged directly underneath the nacelle, and the third is arranged centrally between the first and the second.

A wind turbine having a tower and at least one aerodynamic rotor with at least one rotor blade is proposed, wherein the wind turbine has a measuring arrangement according to at least one of the above embodiments, in particular on its tower, and/or a method is carried out according to at least one of the above embodiments.

The tower of the wind turbine can be of any desired design here. Basically, in addition to the steel tube towers and hybrid towers, grid towers can also be mentioned, to name only a few examples.

### BRIEF DESCRIPTION OF THE SEVERAL VIEWS OF THE DRAWINGS

The present invention will now be explained in more detail below by way of example using exemplary embodiments and with reference to the accompanying figures.

FIG. 1 shows a schematic view of a wind turbine having a measuring arrangement.

FIG. 2 shows a schematic view of a pressure sensor film.

FIG. 3 shows a schematic view of a wind turbine having a particularly preferred embodiment of a measuring arrangement.

FIG. 4 shows a schematic view of a profile of the wind pressure at a piezo-electric pressure sensor film.

FIG. 5 shows a schematic view of a profile of the wind pressure at three piezo-electric pressure sensor films which are arranged around a tower.

FIG. 6 shows a schematic view of a profile of the wind pressure at a piezo-electric pressure sensor film in cross section.

FIG. 7A shows a profile of wind turbulence at a wind turbine.

FIG. 7B shows a profile of wind shear and wind veer at a wind turbine.

FIG. 7C shows a profile of wind veer at a wind turbine over several weeks.

FIG. 7D shows an averaged wind veer between the height of the hub and the tip, during the day and at night, on a wind turbine.

FIG. 8 shows a block diagram of system incorporating measuring devices.

### DETAILED DESCRIPTION

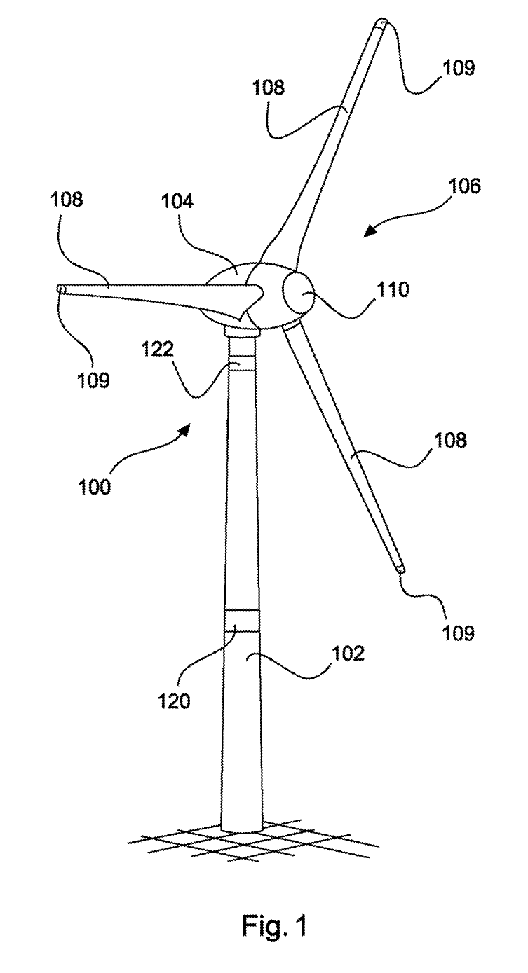

FIG. 1 shows a wind turbine 100 with a tower 102 and a nacelle 104. An aerodynamic rotor 106 with rotor blades 108, which each have a blade tip 109, and a spinner 110, are arranged on the nacelle 104. The rotor 106 is made by the wind to move in rotation during operation and as a result drives a generator in the nacelle 104.

In addition, two measuring devices 120 and 122 are arranged at different heights on the tower 102 of the wind turbine 100 in such a way that they sense wind values for different horizontal directions at the respective height at which they are arranged, said wind values being representative of a wind pressure from the respective direction.

The first measuring device 120 is arranged here on the tower and underneath the second measuring device 122 in such a way that both the first and the second measuring devices 120 and 122 lie within the swept rotor area. The first measuring device 120 is arranged far below in a region in which the respective blade tips 109 pass the tower. The second measuring device 122 is arranged directly underneath the nacelle 104.

In addition, the first and second measuring devices 120 and 122 are arranged as a belt around the tower in such a way that each measuring device can sense a direction-dependent pressure profile over 360° in the horizontal direction.

The first and second measuring devices 120 and 122 therefore essentially form a measuring arrangement according to one embodiment, wherein elements for transmitting data and evaluating data can also be added.

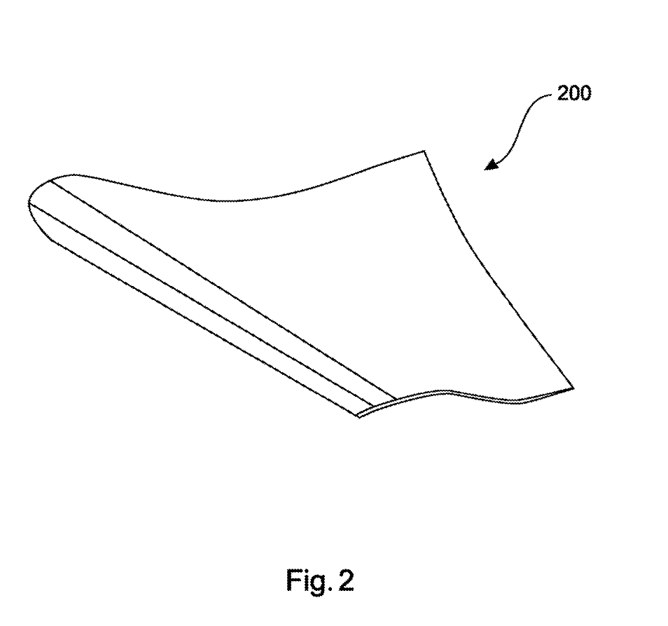

FIG. 2 shows a schematic view of a section of a pressure sensor film 200 which can be arranged as a measuring device on the tower.

The pressure sensor film 200 is embodied here, in particular, as a piezo-electric film or as a nanosensor film and has a thin and essentially web-like design which permits particularly simple installation on the tower of the wind turbine, for example by bonding on. Piezo-electric films can have a thinness of less than 100 μm here, a width of over 30 cm and virtually any desired length.

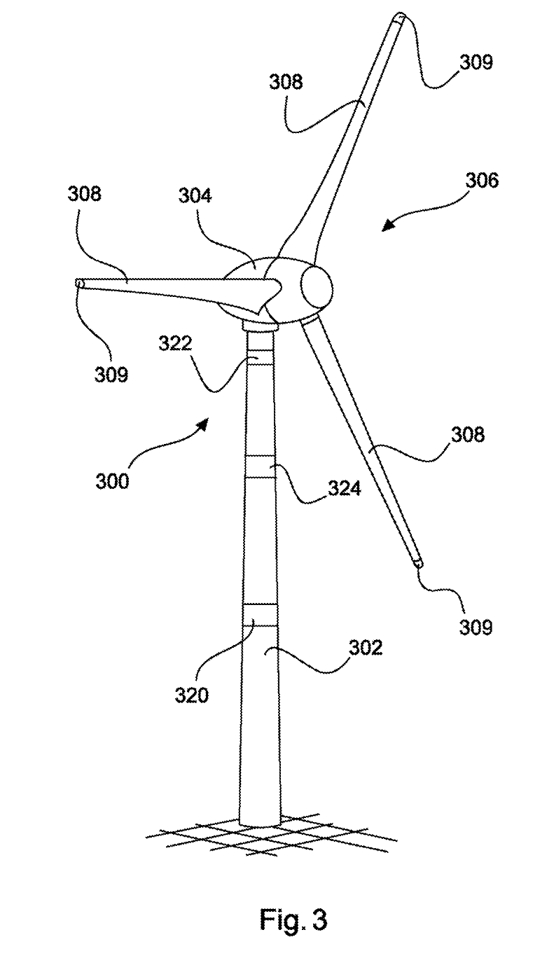

FIG. 3 shows a schematic view of a wind turbine 300 according to a further embodiment which has a measuring arrangement which comprises three measuring devices, specifically three piezo-electric pressure sensor films 320, 322 and 324. The three piezo-electric pressure sensor films are arranged here as a belt around the tower 302.

The first piezo-electric pressure sensor film 320 is also arranged on the tower 302 at a height at which the blade tip 309, which can also be referred to as a tip, passes the tower 302 during the rotation of the rotor 306. Accordingly, the first piezo-electric pressure sensor film 320 is arranged at the lower edge of the swept rotor area over which the rotor blades 308 pass.

The second piezo-electric pressure sensor film 322 is arranged on the tower 302, around the tower directly underneath the nacelle 304.

The third piezo-electric pressure sensor film 324 is arranged on the tower 302, around the tower centrally between the first and second piezo-electric pressure sensor films.

The measuring arrangement is therefore prepared so as to sense at least one value of the wind shear over the height and/or at least one value of the change in the wind direction over the height.

In this arrangement, higher accuracy can be achieved compared to the embodiment in FIG. 1. Wind veer values and wind shear values can be recorded with good accuracy even though the design is embodied in a comparatively simple and cost-effective way. Only three pressure sensor films and one evaluation unit are required.

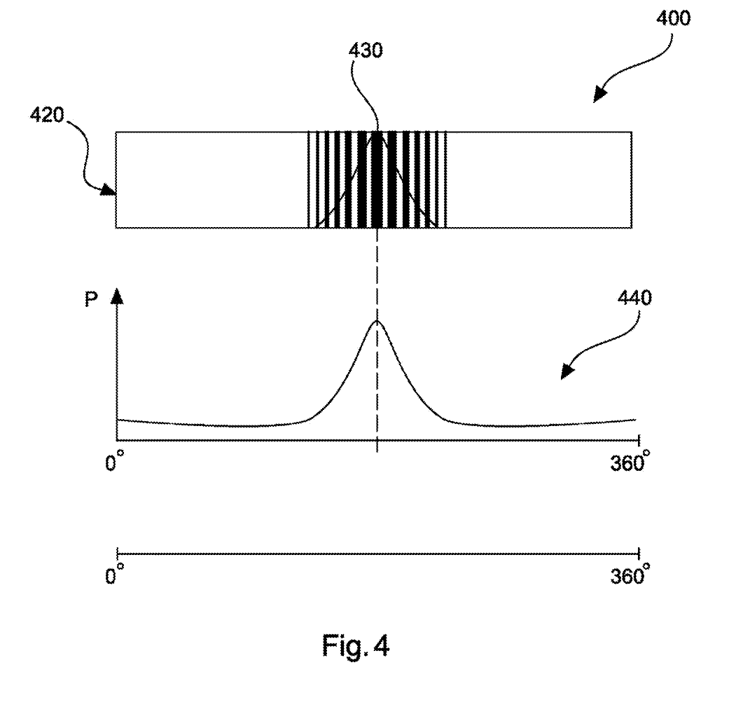

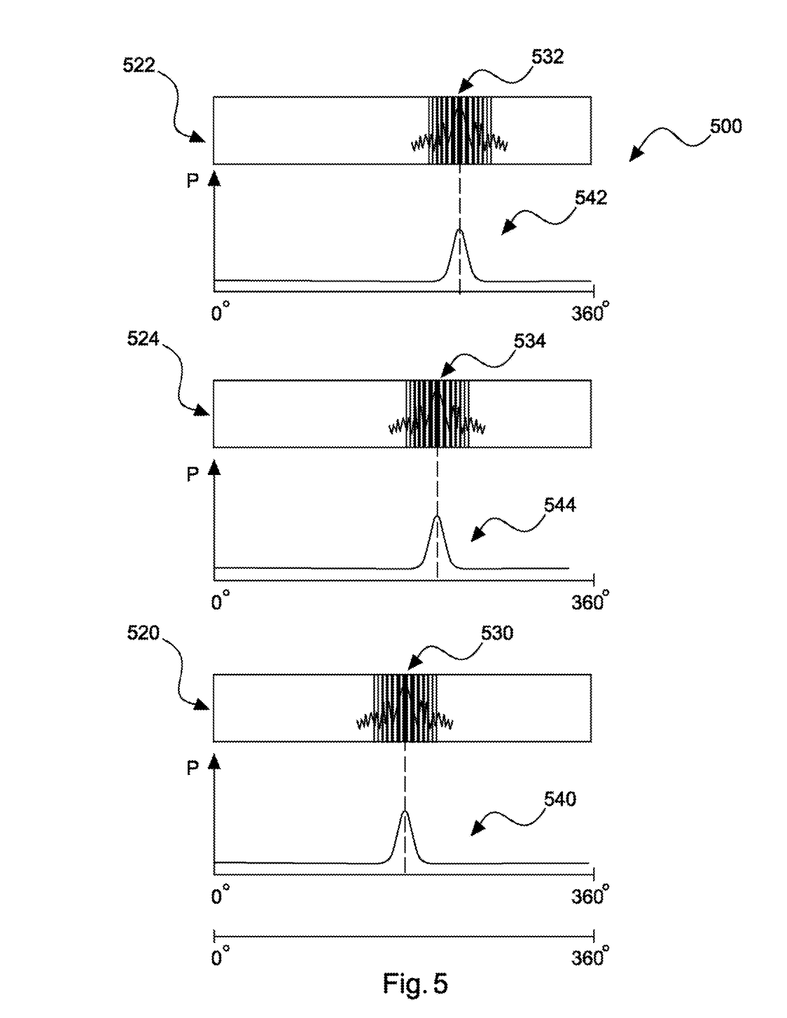

FIG. 4 shows a schematic view, in different representations, of distribution of the wind pressure 400, or 440, of a pressure sensor film 420 which runs around the tower. The illustration in FIG. 4—and the same applies to the illustrations in FIG. 5—respectively shows, in an upper part of the figure, a plan view of the respective pressure sensor film, and illustrates the respective pressure namely in a type of illustration a pressure intensity on the respective pressure sensor film 420 or 520, 522 and 524 by means of corresponding black color intensity or density of the black points. In each case, in an illustration located below, the sensed pressure P is plotted as a diagram against the length of the pressure sensor film 420 or 520, 522 and 524.

The pressure sensor film 420 runs completely around the tower here, that is to say from 0° to 360° in the horizontal direction, but is illustrated as an unrolled pressure sensor film 420 or pressure sensor film 520, 522 and 524 in FIG. 4 and in FIG. 5. This pressure sensor film is therefore prepared so as to map the distribution of the wind pressure around the tower, specifically through 360° in the horizontal direction. A pressure sensor film which is arranged around the tower in this way has a multiplicity of wind values which are each representative of a wind pressure. In addition, the multiplicity of wind values has a maximum wind value 430, which is assumed as a wind direction and which is at approximately 180° here.

FIG. 5 shows a schematic view, in different types of illustration, of in each case a profile of the wind pressure 500 or 540, 542 and 544 at three pressure sensor films 520, 522 and 524 which are arranged at different heights around a tower. The three piezo-electric pressure sensor films 520, 522 and 524 run completely around the tower here from 0° to 360° in the horizontal direction, but at different heights, as shown in FIG. 3, wherein the films 520, 522 and 524 correspond to the films 320, 322 and 324 according to FIG. 3. Each of the pressure sensor films has a maximum wind value 530, 532 and 534 in different horizontal directions. This respective direction is adopted as a wind direction at the respective height at which the pressure sensor film is actually arranged.

As a result, different wind directions are present at different heights and, under certain circumstances, with different pressure values. Different wind strengths can be derived therefrom, said wind strengths varying over the height and therefore being suitable for calculating a wind shear value or a wind shear profile. At least one wind shear value is determined from the respective wind direction at the respective height. The wind shear values and/or wind veer values which are determined in this way can subsequently be extrapolated for the entire swept rotor area. A wind shear profile and/or wind veer profile with which the control of the wind turbine can be improved can also be created from the wind shear values and/or wind veer values which are determined in this way.

FIG. 6 shows a profile of the wind pressure at a piezo-electric pressure sensor film in cross section 600. The film is arranged over 360° around the tower in the horizontal direction at a height on a wind turbine.

The pressure curves 610, 620 and 640 show here by way of example the pressure profile transversely with respect to the pressure sensor film, that is to say along the height of the tower.

Owing to the design and/or the method of functioning of the sensor, it can be found that the sensed wind pressure drops, for example, at the upper edge and/or lower edge of the sensor, that is to say has been measured inaccurately, as is shown for example by the curve 620. However, such absolute measuring inaccuracies, and others like them, can easily be filtered out.

In addition, the sector through 170° in the horizontal direction has the highest pressures, that is to say this sector corresponds to the wind direction. Accordingly, the wind comes, on average, from 170° in the horizontal direction.

In addition, FIG. 6 also shows that the highest pressure value is not limited to a single value but instead the highest pressure value is determined from a multiplicity of pressure values above a predetermined threshold value and therefore the wind direction is subsequently determined from the highest pressure value which is determined in this way.

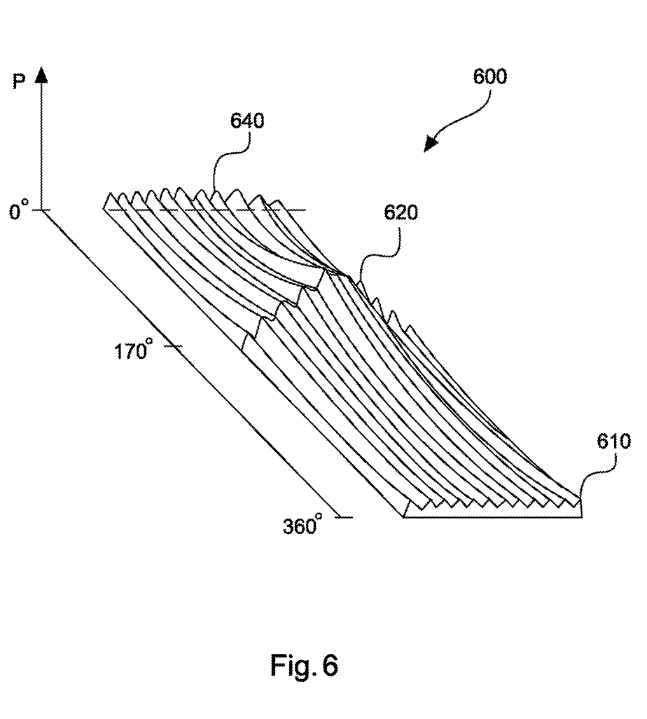

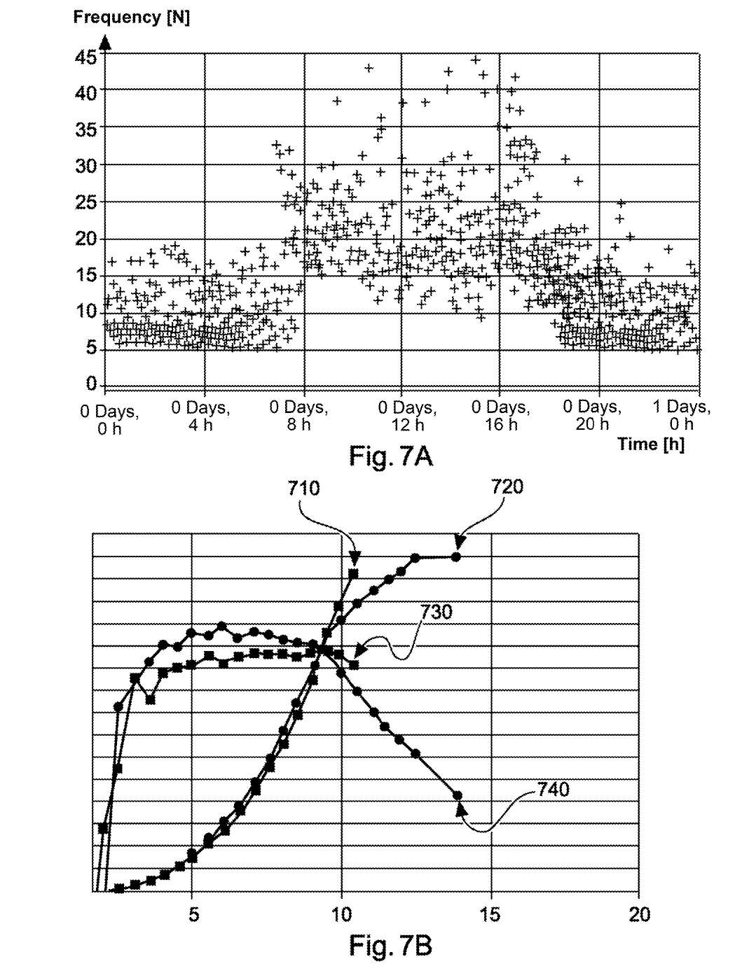

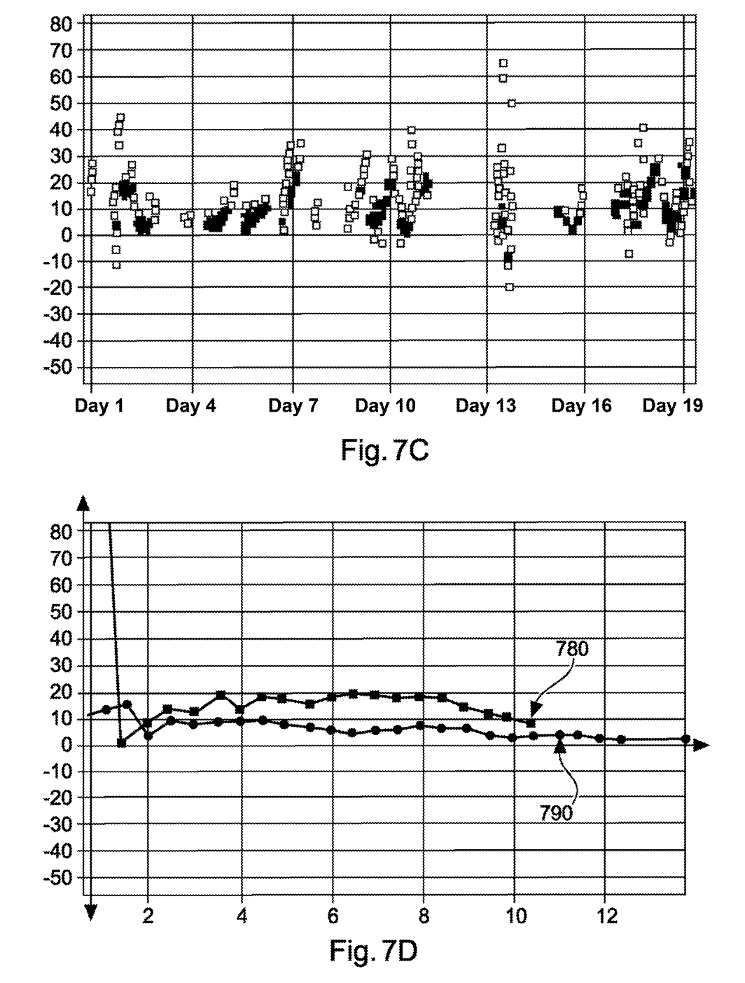

FIG. 7A shows a profile of wind turbulence at a wind turbine over the time period of one day. In particular, during the day, between 8 am and 8 pm, the wind has a large number of occurrences of turbulence. The occurrence of such wind turbulence is not limited to complex locations. Instead, wind turbulence occurs at all locations which have an unstable or windy atmosphere.

FIG. 7B shows a profile of the wind shear and wind veer at a wind turbine over the time period of one day. The curve 710 shows the night profile of the wind veer, and the curve 730 shows the day profile. The curve 720 shows the profile of the wind shear at night, and the curve 740 shows it during the day.

FIG. 7C shows the profile of the wind veer at a wind turbine over several weeks.

FIG. 7D shows an averaged wind veer profile between the height of the hub and the tip on a wind turbine, for the day 790 and for the night 780. These values have been recorded with a very complex method and show, in particular, the need for a method for sensing the wind veer. The recorded values have been bin-averaged, that is to quantized by means of what is referred to as “binning” for a statistical statement.

In order to minimize or compensate the adverse influences on the power curve of a wind turbine, shown in FIGS. 7A to 7D, it is proposed to adapt the control of the wind turbine in such a way that the effect of the wind shear and/or of the change in the wind direction over the height does not have an adverse influence on the output or the coefficients of power of the wind turbine. For this purpose, at least one method and/or one arrangement and/or device according to one of the preceding claims are/is proposed.

By means of a measuring arrangement as proposed it is possible, for example, to determine the wind direction in a particularly simple way, since the highest or largest pressure measured by a sensor corresponds to the wind direction.

The proportionality—the higher the pressure the higher the wind speed—can also be used as an additional indication for determining a corresponding wind speed, for example by means of empirical data collection in combination with a look-up table or by previous calibration of the arrangement, for example by means of an anemometer which has already been previously installed on the roof of the nacelle.

The absolute accuracy of the measuring sensors used may be secondary here, at any rate if, in particular, the relative profile of the wind veer and of the wind shear by means of the swept rotor area is significant.

The measured values which are generated by such an arrangement can also additionally be filtered. For example, to minimize the influence of passing rotor blades on the measuring arrangement, the measuring arrangement can be coupled to the rotor blade positioning system of the wind turbine. However, other devices and/or methods for filtering the sensed data are also conceivable.

The data which is filtered in this way can also be filtered, in particular bin-averaged and used to control the pitch angles and/or azimuth angles.

For example, the pitch angle of the individual rotor blades can be set as a function of the height by 1° or 3° or more degrees over the height. It is also conceivable, in the case of very strong wind veer and/or wind shear to rotate the entire wind turbine in and/or out of the wind by means of the azimuth, for example through 1° azimuth in the case of 10% wind shear over the height of the swept rotor area.

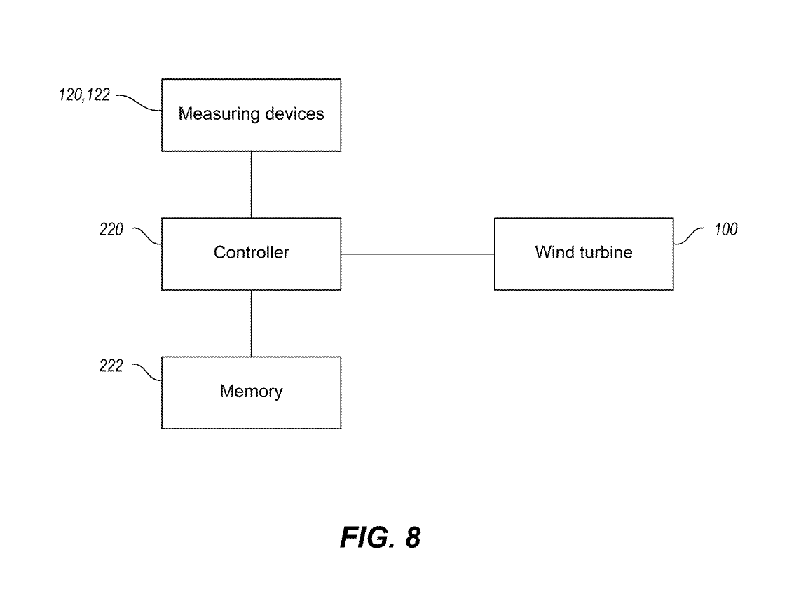

FIG. 8 shows a block diagram of a system that incorporates the measuring devices as described herein, such as the measuring devices 120 and 122. The system further includes a controller 220, which may be any control unit including a processor, and performs the functions of the computational and/or evaluation unit described above. The controller 220 is coupled to a memory 222 to record data received by the measuring devices 120 and 122 and generated by the controller 220. The controller 220 may include the memory itself or may be externally coupled to the memory. The controller 220 is coupled to the wind turbine and configured to control the wind turbine based on the determined wind values.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A measuring arrangement of a wind turbine having a tower and an aerodynamic rotor with at least one rotor blade, for sensing wind conditions, the measuring arrangement comprising
a first measuring device and a second measuring device for arrangement at different heights on the tower,
wherein the first and second measuring devices are prepared so as to sense, at the respective height at which it is to be arranged, wind values for different horizontal directions, said wind values being representative of a wind pressure from the respective direction.

2. The measuring arrangement according to claim 1, wherein the first and second measuring devices are prepared for arrangement around the tower and configured to sense wind pressure.

3. The measuring arrangement according to claim 1, wherein the first and second measuring devices comprise a pressure sensor film which is prepared so as to sense a direction-dependent pressure profile.

4. The measuring arrangement according to claim 1, wherein the pressure sensor film is a piezo-electric film or a nanosensor film.

5. The measuring arrangement according to claim 1, wherein the first measuring device is arranged on the tower of the wind turbine at a height at which a rotor blade tip passes the tower during the rotation of the rotor.

6. The measuring arrangement according to claim 5, wherein the second measuring device is arranged above the first measuring device and below the nacelle of the wind turbine.

7. The measuring arrangement according to claim 6, further comprising a third measuring device for arrangement on the tower at a height between the first and second measuring devices.

8. The measuring arrangement according to claim 1, wherein the measuring arrangement is configured to sense at least one value of: a wind shear over the height and at least one value of a change in wind direction over the height (wind veer).

9. The measuring arrangement according to claim 1, wherein the measuring arrangement is configure to determine a measure of wind turbulence from the wind values.

10. A method comprising:
sensing wind conditions at a wind turbine having a tower and an aerodynamic rotor with at least one rotor blade, wherein sensing comprises:
sensing wind values at different heights on the tower; and
recording direction-dependent wind values for different horizontal directions at the different heights,
wherein the wind values are representative of a wind pressure from the respective horizontal direction.

11. The method according to claim 10, further comprising operating the wind turbine, wherein the wind turbine is operated as a function of the wind values sensed.

12. The method according to claim 10, further comprising determining a wind direction at the first height and at the second height, respectively, and determining a change of wind direction over the height (wind veer).

13. The method according to claim 10, wherein at least at the respective height, the horizontal direction with the largest wind value is determined to be the wind direction at the respective height.

14. The method according to claim 12, comprising at the first height and the second height, determining a wind speed, and deriving a wind shear over the height from the wind speed.

15. The method according to claim 10, comprising deriving a wind speed at the respective height in each case from the largest wind value at the respective height.

16. The method according to claim 14, comprising calculating a wind veer profile or a wind shear profile from the change of wind direction over the height (wind veer) and/or the wind shear over the height for a swept rotor area of the wind turbine.

17. The method according to claim 10, wherein at least one of: an azimuth angle and a pitch angle of the wind turbine is changed as a function of at least one of the following:
a wind shear value,
a wind veer value,
a wind shear profile, and
a wind veer profile.

18. A wind turbine comprising:
a tower;
a nacelle;
an aerodynamic rotor;
at least one rotor blade; and
first and second measuring devices arranged at different heights on the tower, the first and second measuring devices being configured to sense wind from different directions.

19. The wind turbine according to claim 18, wherein the first measuring device is arranged at a height on the tower at which a blade tip of the at least one rotor blade passes the tower during the rotation of the rotor.

20. The wind turbine according to claim 19, wherein the second measuring device is arranged on the tower at a height that is above the first measuring device and below the nacelle.

21. The wind turbine according to claim 20, wherein the second measuring device is arranged on the tower directly below the nacelle.
